(19) United States
(12) Patent Application Publication
(10) Pub. No.: US 2013/0134318 A1
(43) Pub. Date: May 30, 2013

(54) BEAM LINE FOR A SOURCE OF EXTREME ULTRAVIOLET (EUV) RADIATION

(71) Applicants: Reza Abhari, Forch/ZH (CH); Andrea Giovannini, Lugano/TI (CH); Franz Dieterich, Zurich/ZH (CH)

(72) Inventors: Reza Abhari, Forch/ZH (CH); Andrea Giovannini, Lugano/TI (CH); Franz Dieterich, Zurich/ZH (CH)

(21) Appl. No.: 13/637,260

(22) PCT Filed: Mar. 16, 2011
(86) PCT No.: PCT/EP2011/001303

§ 371 Date: Feb. 5, 2013

(30) Foreign Application Priority Data
Mar. 25, 2010 (EP) 10003197.0
Sep. 8, 2010 (EP) 10009339.2

(51) Int. Cl. G02B 19/00; G02B 27/00; G01J 1/04

(52) U.S. Cl. CPC G02B 19/0095; G01J 1/0411; G02B 27/0006
USPC 250/372; 359/355

(57) ABSTRACT

The invention relates to a beam line (30) for a source of extreme ultraviolet (EUV) radiation, wherein a EUV-radiating plasma is generated by irradiating droplets of a suitable target material with a focused laser beam (5) at a plasma generation point, said beam line (30) comprising within a vacuum chamber (7): a beam delivery system (2) comprising a focusing lens and means for cooling and shielding said focusing lens; a EUV mirror collector (1), which collects and focuses the radiated EUV in a EUV beam (6) at an intermediate focus (IF); a beam dump (3) capable of damping at least a portion of the laser beam (5) without imposing a shadow on the collected and focused EUV beam (6); and an intermediate focus module (4) for blocking particles from leaving the vacuum chamber (7) with the EUV beam (6).

### BACKGROUND OF THE INVENTION

1. Field of the Invention

The present invention relates to the generation of extreme ultraviolet radiation. It refers to a beam line for a source of extreme ultraviolet (EUV) radiation.

2. Discussion of Related Art

The next generation of semiconductor devices will be manufactured using extreme ultraviolet (EUV) lithography. EUV light is electromagnetic radiation with wavelengths between 20 nm and 10 nm. In EUV sources, a EUV-emitting plasma is produced by irradiating a target material, e.g., tin (Sn). The radiation exciting the target material can be a laser beam, thus producing a laser produced plasma (LPP). The EUV radiation is collected by a collector optic, e.g., a collimating mirror, and directed to an intermediate region for utilization outside of the EUV light source. Configurations of such EUV sources are shown in documents WO 2006/091948(A1) or WO 2009/025557(A1) or WO 2010/017892(A1), for example.

The problems addressed by the patent and caused by the plasma and debris generation are the following: The focusing lens gets hot and covered by contaminants; this can cause the breaking of the lens. The laser beam that is not absorbed by the targets has to be dumped, in a way that doesn't influence the EUV beam. The connection between the source chamber and the next chamber has to be such that the EUV can go through without any additional absorption, but no particles should go in the next chamber. The contamination has to be avoided.

### SUMMARY OF THE INVENTION

It is an object of the present invention to create a beam line for a source of extreme ultraviolet (EUV) radiation to manage the light beams in the source chamber in a safe and controllable manner.

This object is obtained by a beam line according to claim 1, which comprises within a vacuum chamber a beam delivery system comprising a focusing lens and means for cooling and shielding said focusing lens; a EUV mirror collector, which collects and focuses the radiated EUV in a EUV beam at an intermediate focus; a beam dump capable of damping at least a portion of the laser beam without imposing a shadow on the collected and focused EUV beam; and being used as a support for radiation-sensitive sensors; and an intermediate focus module for blocking particles from leaving the vacuum chamber with the EUV beam.

The laser beam is brought in the chamber by the light delivery system and it is focused. The radiation that is not used is then absorbed in the beam dump. The EUV that is produced thanks to the focalized laser beam is collected by an ellipsoidal mirror, and is focused in its intermediate focus. The EUV beam in the intermediate focus enters then a module that separates the source vacuum chamber from the next stage, letting the radiation going through without a noticeable increase in the EUV absorption. The intermediate focus module is designed so that the gas in the main chamber cannot enter in the next stage.

An embodiment of the invention is characterized in that the focusing lens is cooled by a fluid supplied from outside the vacuum chamber.

According to another embodiment of the invention the focusing lens is shielded from debris by a gas ejected from the outer border of the focusing lens and directed along the surface of the focusing lens.

According to another embodiment of the invention the focusing lens is cleaned by a gas ejected from the outer border of the focusing lens and directed along the surface of the focusing lens.

According to another embodiment of the invention the gas ejected from the outer border of the focusing lens is being selected from the group containing hydrogen, helium, argon, neon, krypton, xenon, chlorine, fluorine, bromine, and iodine.

According to another embodiment of the gas is a mixture of a plurality of those gases, and/or the gas is ionized.

According to another embodiment of the invention the beam dump is cooled by a fluid, and that the cooling fluid passes through an internal cooling channel provided in a beam dump casing.

According to another embodiment of the invention at least two pipes are connected to the beam dump to assure flow inlet and outlet and hold the beam dump in position.

According to another embodiment of the invention radiation- and/or plasma-sensitive sensors are mounted on a side of the beam dump facing the plasma.

According to another embodiment of the invention the beam dump comprises at least one cone for receiving the laser beam, whereby sensor electronics is stored and protected against radiation in a sensor space behind the at least one cone.

According to another embodiment of the invention the sensors are used for alignment, triggering, and monitoring of the plasma, radiation, and clouding.

According to another embodiment of the invention two cones made of different material are provided within the beam dump, whereby a first cone is made of a high thermal conductive material, and a second cone is placed within the first one and is made of a material with a high melting point.

According to another embodiment of the invention the cooling fluid is selected from a group containing water or oil.

According to another embodiment of the invention the intermediate focus module is shielded from debris and suspended particles by a gas ejection.

According to another embodiment of the invention the intermediate focus module comprises at least three sub chambers, whereby the sub chambers are arranged one within the other as an outer sub chamber, an intermediate sub chamber and an inner sub chamber.

According to another embodiment of the invention a gas is ejected between the outer sub chamber and the intermediate sub chamber, such that it flows primarily in direction of the vacuum chamber.

According to another embodiment of the invention all sub chambers comprise a central hole, and that the hole of the intermediate sub chamber is smaller than the hole of the outer sub chamber.

According to another embodiment of the invention the hole of the intermediate sub chamber can be adjusted along the direction of the EUV beam.

According to another embodiment of the invention the pressure in a space between outer sub chamber and the intermediate sub chamber is higher than the pressure in the vacuum chamber outside of the intermediate focus module, and is higher than the pressure in the space between the intermediate sub chamber and the inner sub chamber), and the pressure in an interface within the inner sub chamber, while the pressure in the space between the inner sub chamber and the intermediate sub chamber is lower than the pressure in the interface within the inner sub chamber.

According to another embodiment of the invention the position of the intermediate focus module can be adjusted, in order to have the focus of the radiation centered within the sub chambers.

According to another embodiment of the invention a, preferably cooled, spectral purity filter is added in the interface within the inner sub chamber, in order to let pass just the radiation of interest.

According to another embodiment of the invention the gas is selected from a group containing hydrogen, helium, argon, neon, krypton, xenon, chlorine, fluorine, bromine, and iodine.

According to another embodiment of the invention the gas is a mixture of a plurality of those gases, and/or the gas is ionized.

According to another embodiment of the invention the EUV mirror collector is part of a beam deflecting system, which comprises at least a focusing mirror, which focuses the deflected radiation in the EUV beam at the intermediate focus.

According to another embodiment of the invention an additional planar deflecting mirror is provided, which deflects a small part of the generated EUV radiation onto the focusing mirror.

According to another embodiment of the invention the beam deflecting system is placed in an enclosure, which is provided with a beam entrance port for the incoming EUV radiation and a beam exit port for releasing the focused EUV beam on its way to the intermediate focus module.

According to another embodiment of the invention the enclosure comprises a first mirror container enclosing the first deflecting mirror, in the distance from the said first mirror container a second mirror container enclosing the second focusing mirror, and a connecting tube for connecting the two mirror containers, such that the EUV beam running from the first mirror to the second mirror and the focused EUV beam running from the second mirror to the beam exit port are enclosed by said connecting tube.

According to another embodiment of the invention the enclosure is mounted on an adjusting plate, which can be rotated in a plane parallel to the plane of the deflected EUV beam.

According to another embodiment of the invention the pressure within the enclosure is higher than the pressure in the surrounding vacuum chamber, such that debris is prevented from entering the beam entrance port of the enclosure.

According to just another embodiment of the invention the focused EUV beam leaves the vacuum chamber in the direction, which is essentially opposite to the direction of the entering laser beam.

According to another embodiment of the invention a higher pressure in the enclosure is achieved by means of at least one gas ejector, which directs ejected gas onto the mirror facing the plasma.

According to another embodiment of the invention the enclosure is provided with a beam entrance part, which is preferably exchangeable, and the hole area and the flow ejection direction of which can preferably be varied.

### BRIEF DESCRIPTION OF THE DRAWINGS

The present invention is now to be explained more closely by means of different embodiments and with reference to the attached drawings.

FIG. 1 shows a first embodiment of the beam line according to the invention and its components;

FIG. 2 shows an embodiment of the beam delivery system of FIG. 1 around the focusing lens;

FIG. 3 shows where the laser enters the beam delivery system of FIG. 2;

FIG. 4 shows an embodiment of the beam dump of FIG. 1;

FIG. 5 shows an embodiment of the intermediate focus module of FIG. 1;

FIG. 6 shows in the top view a second embodiment of the beam line according to the invention with a two-mirror configuration;

FIG. 7 shows the main components the embodiment according to FIG. 6 in a perspective view; and

FIG. 8 shows in the top view a third embodiment of the beam line according to the invention with only one small deflecting and focusing mirror.

### DETAILED DESCRIPTION OF THE INVENTION

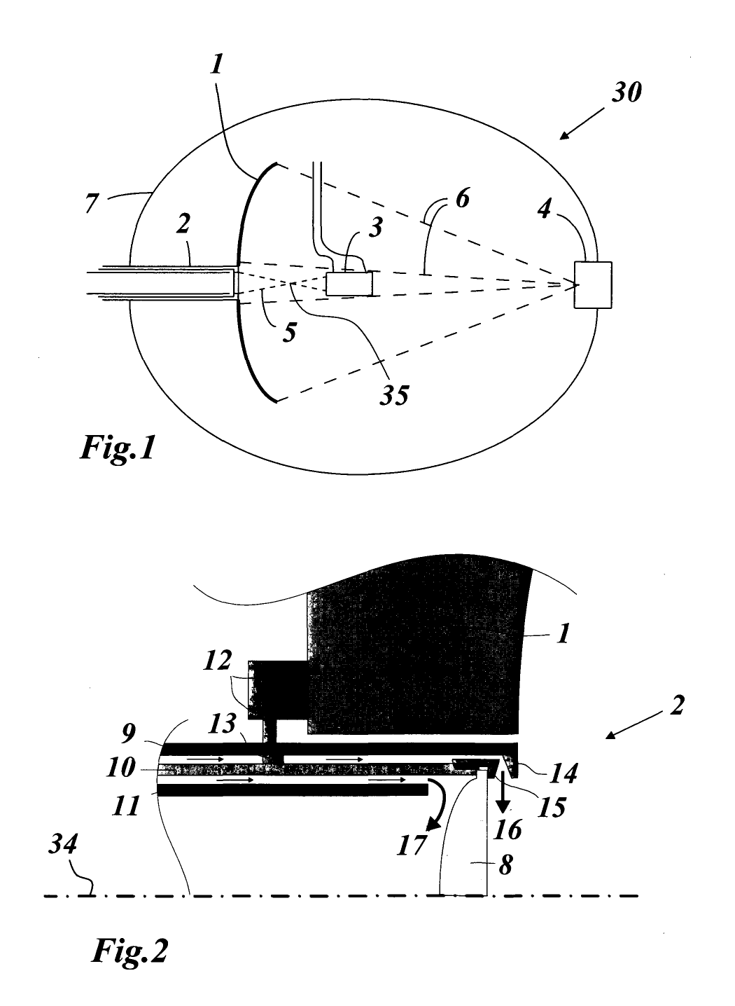

The beam line 30 according to FIG. 1 comprises at least four elements arranged in a vacuum chamber 7: a laser beam delivery system 2, a laser beam dump 3, a EUV collector mirror 1 with an ellipsoidal shape in operation, and an intermediate focus module 4. Not shown in FIG. 1 is a device for generating droplets of a liquid, e.g. molten Sn, which are ejected to a reach plasma generation point 35, where they are turned into plasma by means of a focused laser beam 5.

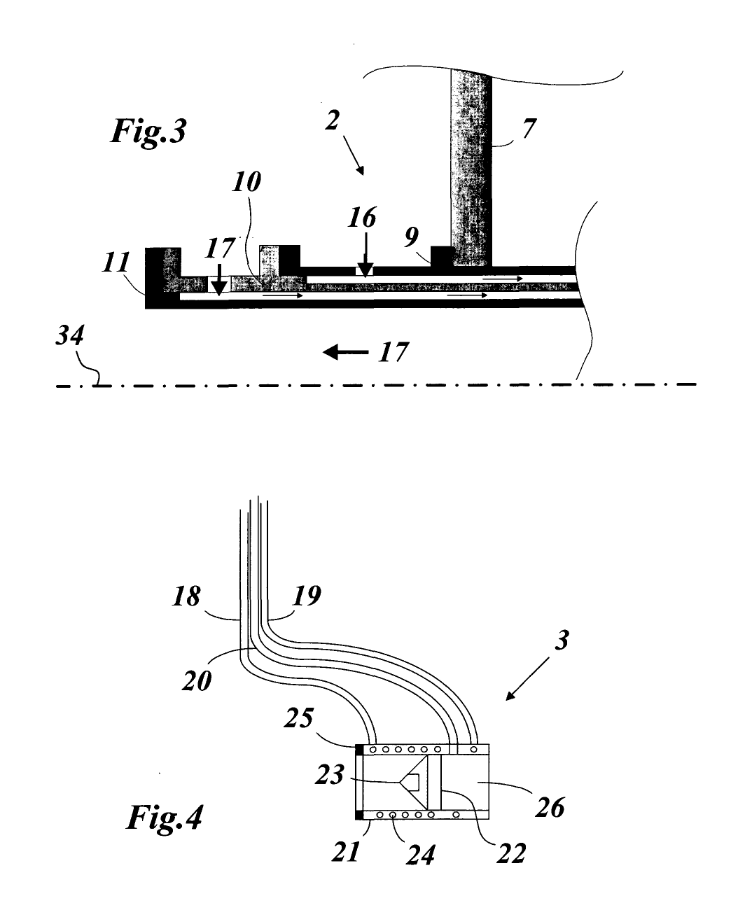

The beam delivery system 2 shown in FIGS. 2 and 3 is designed to place a focusing lens 8 close to the plasma generation point 35, in order to minimize the spot size dimension (minimize the diffraction) at an intermediate focus located at the intermediate focus module 4.

The beam delivery system 2 comprises a plurality of concentric tubes, i.e. an outer tube 9, an intermediate tube 10, and an inner tube 11, which reach from the wall of the vacuum chamber 7 to the location of the laser focusing lens 8. The focusing lens 8 is positioned on the axis 34 of the EUV mirror collector 1. A collimated laser beam 5 enters the assembly through the inner tube 11 and is focused to the primary focus (at the plasma generation point 35) of the system by the focusing lens 8. The focusing lens 8 is mounted on the front of the intermediate tube 10 and held in position by a threaded ring 15.

Between the outer tube 9 and the lens carrying intermediate tube 10 a concentric duct is established, which allows a gas suitable for a mitigation of the plasma-induced debris to flow to the front of the focusing lens 8, where it is ejected radially through a convergent-divergent planar nozzle (14, 15) into the vacuum chamber 7 to build up a lens gas curtain 16 (FIG. 2). This enables the flow to achieve supersonic velocity. The nozzle is shaped by the threaded ring 15 and by another ring 14 attached to the outer tube 9. The inner tube 11 guides a cooling gas 17 between itself and the lens carrying intermediate tube 10 towards the focusing lens 8. There the cooling gas 17 impinges onto the lens 8 and escapes through the inner tube 11 to the atmosphere (FIG. 2).

Positioning devices 12, which are fixed to the vacuum chamber 1 (collector casing) and push the concentric tubes 9, 10 and 11 in radial direction, allow a micro-positioning of the focusing lens 8 on the axis 34 of the EUV mirror collector 1. Distance pieces 13 between the outer tube 9 and the lens carrying intermediate tube 10 transfer this radial motion to the lens 8.

The lens gas curtain 16 for debris mitigation and the cooling gas 17 are injected in between the concentric tubes 9, 10 and 11 at the outside of the vacuum chamber 7 (see FIG. 3). The lens carrying intermediate tube 0 and the threaded ring 15, which holds the lens 8 in place, are designed to withstand the pressure difference between atmosphere and the vacuum. The lens gas curtain 16 can be also used as a cleaning means for the inner lens surface, using a cleaning gas or a mixture of the debris mitigation gas (preferably Argon) and the cleaning gas.

The laser beam 5, after being focused by the beam delivery system 2, irradiates the droplets mentioned before. However, not all of each laser pulse and not every pulse are assumed to be absorbed by the droplets. The part of the laser beam 5 that is not absorbed, continues in his path, diverges, and enters the beam dump 3.

The beam dump 3 (FIG. 4) is designed to sustain a power up to 2 kW of absorbed radiation in vacuum, i.e. without the help of natural convection. In the preferred embodiment the beam dump 3 is located in the region, where the EUV beam 6 of collected and reflected EUV radiation doesn't pass. This constrains the dimension and the position of the beam dump 3 in the vacuum chamber 7. A suitable fluid cools the beam dump 3 and passes through an internal cooling channel 24 provided in the wall of the cylindrical beam dump casing 21. The internal cooling channel 24 has a spiral shape and is designed taking into account the pressure drop of the cooling fluid and the total surface area necessary to get the needed heat transfer. The temperature increase of the cooling fluid is designed to be less than 10° C. for a received power up to 2 kW. In order to minimize the shadowing of the EUV beam 6 by the beam dump 3, the beam dump 3 is held in position by a plurality of pipes 18, 19 and 20, which supply and remove the coolant. For the same reason, these pipes, the cooling inlet pipe 18, the cooling outlet pipe 19, and the pipe 20 for the electrical cables are arranged one behind the other in the axial direction.

In the cooled cylindrical beam dump casing 21 a beam dump cone 22, 23 is installed to reflect and absorb the remains of the laser beam 5. The contact area between the cylindrical beam dump casing 21 and the beam dump cone 22, 23 is maximized in order to maximize the heat removed from the cone. The beam dump cone 22, 23 is made out of two different materials: one is used for the outer part (cone 22) in order to optimize heat conduction, while for the tip (cone 23) another material is used in order to maximize the melting point. In a preferred embodiment the material for the outer cone 22 is Aluminum, and the material for the inner cone 23 is Nickel.

On the lip of the cooled cylindrical beam dump casing 21 that faces the plasma, radiation- and/or plasma-sensitive sensors 25 can be mounted. The sensors 25, which are directly cooled, are used for controlling the alignment of the droplets with the beam line and synchronizing of the moving droplets and the laser pulses. Furthermore, the sensors 25 monitor directly the radiation and/or plasma intensity and/or the presence of neutrals (clouding) without imposing a shadow in the EUV beam 6, and without being directly irradiated by the laser beam 5. Behind the cones 22, 23, another space is provided, which is used as a sensor space 26. The sensor space 26 is predisposed to store sensor hardware, to protect it against the incoming laser beam 5. The electrical cable pipe 20, which opens into the sensor space 26, is used to bring the cables of the sensor arrangement out of the beam dump 3. The cooling inlet pipe 18 directly cools the electrical cable pipe 20, since these are in contact (FIG. 4). The cooling fluid can be chosen from a variety of different fluids, especially including water and oil.

In a preferred embodiment the beam dump 3 is coated with paint, without carbon, that enhances the absorption of the laser light. In another embodiment no coating is used, so that the chamber and the collector are not contaminated.

The EUV beam 6, after reflection from the multilayer EUV mirror collector 1, is focused to give the intermediate focus of the ellipsoidal collector mirror. At the intermediate focus (IF) the intermediate focus module 4 is integrated in order to prevent ions and neutrals to enter the next stage (not shown in FIG. 1), which is situated at the exit of the beam line 30 to receive and use the EUV radiation. The intermediate focus module 4 can be moved to be centered with respect to the EUV beam 6. In order to shield the intermediate focus module 4, a gas flow is used.

The intermediate focus module 4 comprises three sub chambers 27, 28 and 29, which are contained one within the other, and are each provided with a central opening or hole. A gas is injected between the outer sub chamber 27 and the intermediate sub chamber 28, and is ejected mainly into the vacuum chamber 7. In order to minimize the amount of gas that flows in the space 32 between the intermediate sub chamber 28 and the inner sub chamber 29, the hole in the intermediate sub chamber 28 is smaller than the hole in the outer sub chamber 27. In order to have the hole in the intermediate sub chamber 28 as small as possible, in a preferred embodiment the hole is placed just in the position of the intermediate focus IF. The small amount of gas that goes through the hole in the intermediate sub chamber 28 is then sucked away between the intermediate sub chamber 28 and the inner sub chamber 29, where the pressure is the lowest in the system. This pressure is also smaller compared with the pressure inside the inner sub chamber 29, where there is the interface 33 with the next stage. This leads to a small flux that exits the inner sub chamber 29, and thus prevents any particles to enter.

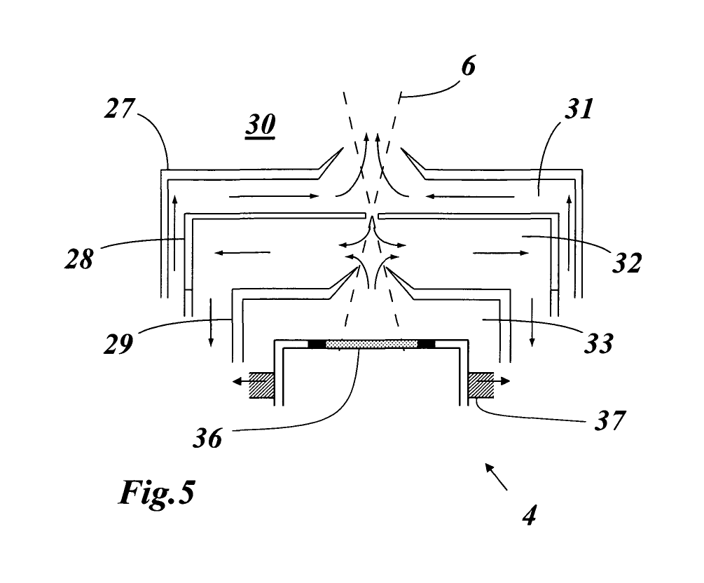

The pressures in the spaces 31, 32 and 33 between the sub chambers should be chosen as follows: the pressure in space 31 is higher than the pressure in the vacuum chamber 30 and the space 32; the pressure in space 32 is lower than the pressure in the interface 33, space 31, and the vacuum chamber 7. The pressure in the interface 33 is generally lower than the pressure in the vacuum chamber 7. But in another embodiment it can be also the opposite. This configuration permits to have a flow circulating as represented in FIG. 5 that blocks particles going from the vacuum chamber 7 to the next stage.

In a preferred embodiment the order of magnitude of the values for the pressure can be chosen as follows: in the vacuum chamber 7: 0.1 mbar; in space 31: 1 mbar; in space 32: 10⁻⁶ mbar or lower, if a pressure lower than 10⁻⁶ mbar is required in the interface 33. In the interface 33 the pressure value depends on the next stage, and is for example 10⁻⁴ mbar. In the EUV path the pressure remains high just for a minimum length; therefore the intermediate focus module 4 doesn't noticeably increase the EUV absorption.

The position of the central hole of the intermediate sub chamber 28 can be controlled. In another embodiment, the position of this hole is moved to a place after the intermediate focus IF, and the hole has a larger diameter, large enough to let the diverging EUV radiation go through.

In the interface 33, clean from contamination, a spectral purity filter 36 can be placed. The spectral purity filter is directly cooled, where a cooling means 37 works through conduction on the side and/or through convection on the surface. In a preferred embodiment the spectral purity filter comprises a Zr film.

The gas used for the intermediate focus module 4 and for the lens debris mitigation is chosen from a variety of different gases, in neutral or ionic state, including: hydrogen, helium, argon, neon, krypton, xenon, chlorine, fluorine, bromine, and iodine. The gas can also be a mixture of the listed gases.

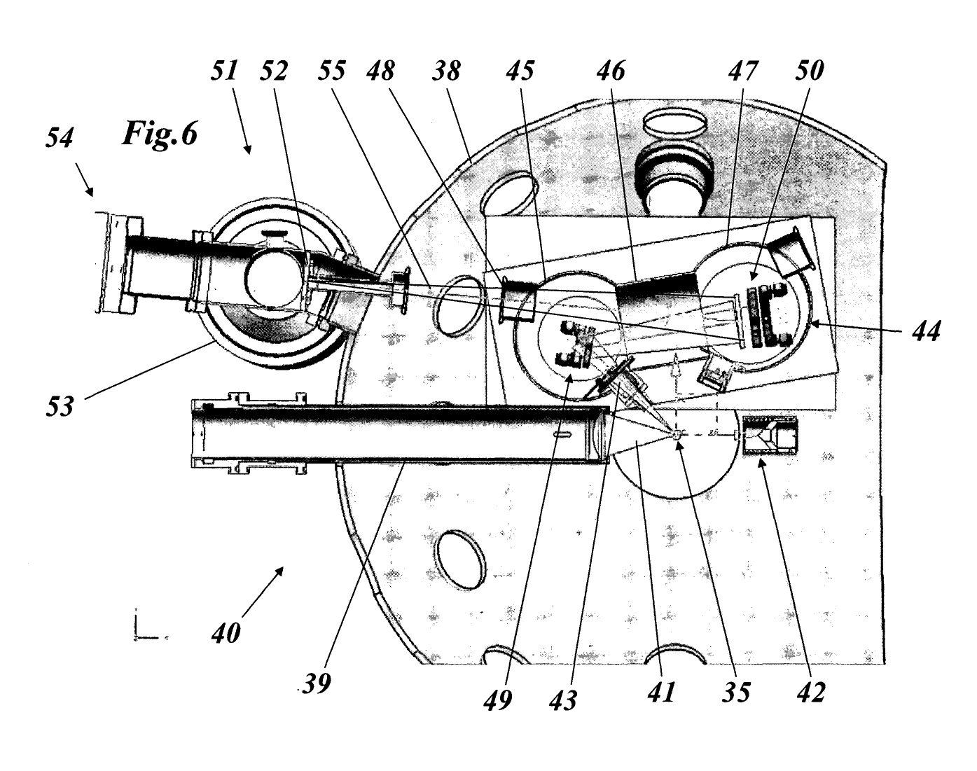

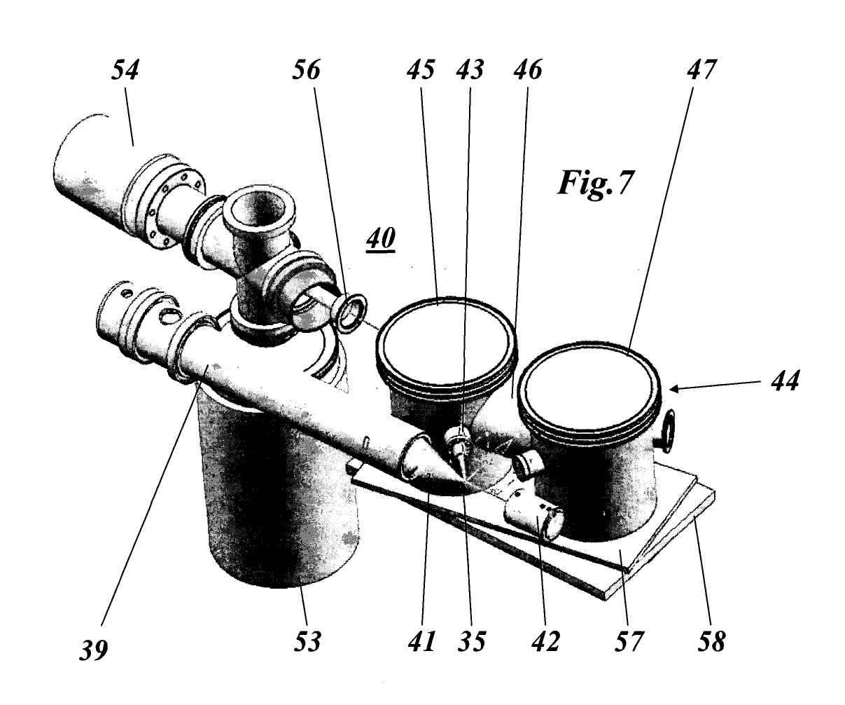

FIGS. 6 and 7 show another embodiment of the beam line according to the invention. The beam line 40 shown in these figures comprises a vacuum chamber 38 in the centre of which the plasma generation point 35 is located. A beam delivery system 39 for delivering a focused laser beam 41 enters the vacuum chamber, such that the laser beam is focused at the plasma generation point 35. On the opposite is side of the beam delivery system 39 the beam dump 42 is placed, which is similar to that shown in FIG. 4.

Different from the arrangement shown in FIG. 1 the EUV radiation emanating from the plasma generation point 35 is not collected and focused by means of a big elliptical mirror. Only a small part of this radiation enters the beam deflecting system 44 through the relatively smart opening of a beam entrance port 43. The beam entrance port 43 is the beam entrance of an enclosure 45, 46 and 47, which contains the beam deflecting system 44. This beam deflecting system 44 comprises a relatively small first mirror 49, which is designed as a planar deflecting mirror. This deflecting mirror 49 deflects the radiation entering the beam entrance port 43 on to the second focusing mirror 50, which is arranged at a distance from the first mirror 49. The focusing mirror 50 focuses the EUV radiation coming from the first mirror 49 into a focused EUV beam 55, which has its focal point at an aperture 52 within an intermediate focus module 51. The focus beam leaves the enclosure 45, 46 and 47 through a beam exit port 48. A guiding tube 56 at the entrance of the intermediate focus module 51 helps to screen any debris from entering the module. Between the aperture 52 and a beam outlet section 54 of the intermediate focus module 51 a vacuum pump is placed for differential pressure purposes.

The enclosure for the beam deflecting system 44 is necessary to keep a pressure inside, which is a little bit higher than in the surrounding vacuum chamber 38, so that a suitable gas as specified before can flow from inside the enclosure through the beam entrance port 43 into the vacuum chamber 38 to protect the first mirror 49 against the degrading effects of the debris.

The enclosure has a simple and stable construction, and it is designed to give easy access to the mirrors 49 and 50, so that the mirrors can be easily adjusted or replaced in case of damage. The enclosure comprises a first cylindrical mirror container 45 containing the first mirror 49, and a second cylindrical mirror container 47 containing the second mirror 50. Both containers 45 and 47 are connected by a cylindrical connecting to 46. The connecting tube 46 is designed such that the EUV beam running from the first mirror 49 to the second mirror 50 and the focused EUV beam 55 running from the second mirror 50 to the beam exit port 48 are enclosed by said connecting tube 46. The enclosure is placed on an adjusting plate 57, which is repeatedly supported by a fixed base plate 58 such that it can be rotated in a plane parallel to the plane of the deflected EUV beam 55.

The containers 45 and 47 of the enclosure are each closed by a detachable lid, so that there is an easy access to the mirrors inside.

Due to the special beam forming system of the second embodiment the resulting EUV source has a high brightness instead of a high power. Thus, the characteristics and advantages of this embodiment are:
The brightness of the source is optimized, which is required for metrology tools.
The cost of the one or two multilayer (ML) mirrors 49 and 50 is much lower than the big elliptical ML mirror (factor greater than 10).
The debris mitigation is directed just to a smaller (not more than 40 mm) diameter optic, instead of 250 mm. The debris mitigation is much more concentrated, and is therefore larger.
In the two mirrors configuration the first mirror 49 is a small planar ML. If the debris mitigation doesn't stop the more energetic ions, this mirror could be replaced as consumable, in order to avoid a long-term loss in reflectivity.
The gas used for debris mitigation can be chosen to have a cleaning effect.
The intermediate focus module 51 is so designed that a contamination is avoided with differential pumping.

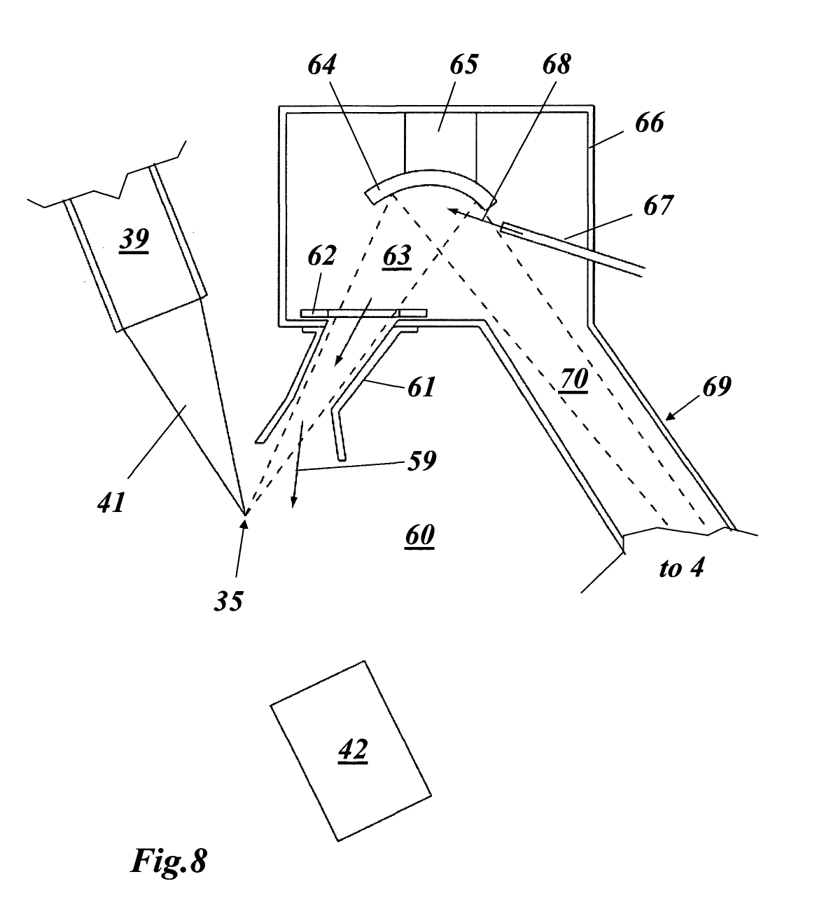

FIG. 8 shows another embodiment of the beam line according to the invention. In the beam line 60 shown in this figure the components are located again in a vacuum chamber (not shown) in the centre of which the plasma generation point 35 is located. A beam delivery system 39 for delivering a focused laser beam 41 enters the vacuum chamber, such that the laser beam 41 is focused at the plasma generation point 35. On the opposite is side of the beam delivery system 39 the beam dump 42 is placed, which is similar to that shown in FIG. 4.

Different from the arrangement shown in FIG. 1 the EUV radiation emanating from the plasma generation point 35 is not collected and focused by means of a big elliptical mirror. Only a small part of this radiation enters the beam deflecting system through the relatively small opening of a beam entrance part 61. The beam entrance part 61 is the beam entrance of an enclosure 66, which contains the beam deflecting system. This beam deflecting system comprises a mirror 64 on a mirror holder 65, which mirror 64 is designed as to reflect and focus the EUV beam 63, 70. The focal point of the EUV beam is at an aperture as shown in FIG. 5 of the subchamber 28 within an intermediate focus module 4. The focus beam is enclosed in the enclosure 66 up to the intermediate focus module 4. The subchamber 27 in FIG. 5 is substituted by the enclosure 66 in FIG. 8.

The enclosure 66 for the beam deflecting system is necessary to keep a pressure inside, which is higher than in the surrounding vacuum chamber, so that a suitable stream of gas as specified before can flow from inside the enclosure 66 through the beam entrance port 61 into the surrounding vacuum chamber to protect the mirror 64 against the degrading effects of the debris.

At the exit of the enclosure 66 the flow is choked, which leads to a locally larger density. The converging part of the beam entrance part 61 that ends with the ejection hole can be exchangeable. One configuration of the converging-diverging part 61 is to have an ejection in the direction of the plasma; another one is to have the hole with an elliptical shape, so that the flow is directed with an angle. A gas ejector 67 enters the enclosure 66 and directs ejected gas 68 onto the mirror 64.

A shutter 62 may be implemented in the system to be able to protect the mirror in case of problems.

1. A beam line (30, 40, 60) for a source of extreme ultraviolet (EUV) radiation, wherein a EUV-radiating plasma is generated by irradiating droplets of a suitable target material with a focused laser beam (5, 41) at a plasma generation point (35), said beam line (30, 40, 60) comprising:
a beam delivery system (2, 39) within a vacuum chamber (7, 38), the beam delivery system (2, 39) comprising a focusing lens (8) and means (9, 10, 11, 13, 14, 15) for cooling and shielding said focusing lens (8);
a EUV mirror collector (1, 50, 64), which collects and focuses the radiated EUV in a EUV beam (6, 55, 63, 70) at an intermediate focus (IF);
a beam dump (3, 42) capable of damping at least a portion of the laser beam (5, 41) without imposing a shadow on the collected and focused EUV beam (6, 55, 63, 70); and
an intermediate focus module (4, 51) for blocking particles and/or radiation from leaving the vacuum chamber (7, 38) with the EUV beam (6, 55, 63, 70).

2. A beam line according to claim 1, wherein the focusing lens (8) is cooled by a fluid supplied from outside the vacuum chamber (7).

3. A beam line according to claim 1, wherein the focusing lens (8) is shielded from debris by a gas ejected from the outer border of the focusing lens (8) and directed along the surface of the focusing lens (8).

4. A beam line according to claim 1, wherein the focusing lens (8) is cleaned by a gas ejected from the outer border of the focusing lens (8) and directed along the surface of the focusing lens (8).

5. A beam line according to claim 3, wherein the gas ejected from the outer border of the focusing lens (8) is selected from the group consisting of hydrogen, helium, argon, neon, krypton, xenon, chlorine, fluorine, bromine, and iodine.

6. A beam line according to claim 5, wherein the gas is a mixture of a plurality of those gases, and/or the gas is ionized.

7. A beam line according to claim 1, wherein the beam dump (3) is cooled by a fluid, and that the cooling fluid passes through an internal cooling channel (24) provided in a beam dump casing (21).

8. A beam line according to claim 7, further comprising at least two pipes (18, 19) connected to the beam dump (3) to assure flow inlet and outlet and hold the beam dump (3) in position.

9. A beam line according to claim 1, further comprising radiation- and/or plasma sensitive sensors (25) are mounted on a side of the beam dump (3) facing the plasma.

10. A beam line according to claim 9, wherein the beam dump (3) comprises at least one cone (22, 23) for receiving the laser beam (5), and that sensor electronics is stored and protected against radiation in a sensor space (26) behind the at least one cone (22, 23).

11. A beam line according to claim 9, wherein the sensors (25) are used for alignment, triggering, and monitoring of the plasma, radiation, and clouding.

12. A beam line according to claim 10, further comprising two cones (22, 23) made of different material provided within the beam dump (3), whereby a first cone (22) is made of a high thermal conductive material, and a second cone (23) is placed within the first one (22) and is made of a material with a high melting point.

13. A beam line according to claim 7, wherein the cooling fluid is selected from a group consisting of water or oil.

14. A beam line according to claim 1, wherein the intermediate focus module (4) is shielded from debris and suspended particles by a gas ejection.

15. A beam line according to claim 1, wherein the intermediate focus module (4) comprises at least three sub chambers (27, 28, 29), and that the sub chambers (27, 28, 29) are arranged one within the other as an outer sub chamber (27), an intermediate sub chamber (28) and an inner sub chamber (29).

16. A beam line according to claim 15, further comprising a gas ejected between the outer sub chamber (27) and the intermediate sub chamber (28), such that it flows primarily in direction of the vacuum chamber (7).

17. A beam line according to claim 15, wherein all sub chambers (27, 28, 29) comprise a central hole, and that the hole of the intermediate sub chamber (28) is smaller than the hole of the outer sub chamber (27).

18. A beam line according to claim 7, wherein the hole of the intermediate sub chamber (28) can be adjusted along the direction of the EUV beam (6).

19. A beam dump according to claim 15, wherein a pressure in a space (31) between outer sub chamber (27) and the intermediate sub chamber (28) is higher than a pressure in the vacuum chamber (7) outside of the intermediate focus module (4), and is higher than a pressure in the space (32) between the intermediate sub chamber (28) and the inner sub chamber (29), and a pressure in an interface (33) within the inner sub chamber (29), while the pressure in the space (32) between the inner sub chamber (29) and the intermediate sub chamber (28) is lower than the pressure in the interface (33) within the inner sub chamber (29).

20. A beam line according to claim 15, wherein the position of the intermediate focus module (4) can be adjusted, in order to have the focus of the radiation centered within the sub chambers (27, 28, 29).

21. A beam line according to claim 15, further comprising a spectral purity filter (36) added in the interface (37) within the inner sub chamber (29)

22. A beam line according to claim 21, wherein the spectral purity filter (36) is cooled (37).

23. A beam line according to claim 16, wherein the gas is selected from a group consisting of hydrogen, helium, argon, neon, krypton, xenon, chlorine, fluorine, bromine, and iodine.

24. A beam line according to claim 23, wherein the gas is a mixture of a plurality of those gases, and/or the gas is ionized.

25. A beam line according to claim 1, wherein the EUV mirror collector (50, 64) is part of a beam deflecting system (44), which comprises at least a focusing mirror (50, 64), which focuses the deflected radiation in the EUV beam (55, 70) at the intermediate focus (IF).

26. A beam line according to claim 25, further comprising an additional planar deflecting mirror (49) is provided, which deflects a small part of the generated EUV radiation onto the focusing mirror (50).

27. A beam line according to claim 25, wherein the beam deflecting system (44) is placed in an enclosure (45, 46, 47; 66), which is provided with a beam entrance port (43, 61) for the incoming EUV radiation and a beam exit port (48) for releasing the focused EUV beam (55, 70) on its way to the intermediate focus module (51).

28. A beam line according to claim 27, wherein the enclosure (45, 46, 47) comprises a first mirror container (45) enclosing the first deflecting mirror (49), in a distance from the said first mirror container (45) a second mirror container (47) enclosing the second focusing mirror (50), and a connecting tube (46) for connecting the two mirror containers (45, 47), such that the EUV beam running from the first mirror (49) to the second mirror (50) and the focused EUV beam running from the second mirror (50) to the beam exit port (48) are enclosed by said connecting tube (46).

29. A beam line according to claim 27, wherein the enclosure (45, 46, 47) is mounted on an adjusting plate (57), which can be rotated in a plane parallel to the plane of the deflected EUV beam (55).

30. A beam line according to claim 27, wherein the pressure within the enclosure (45, 46, 47) is higher than the pressure in the surrounding vacuum chamber (38), such that debris is prevented from entering the beam entrance port (43) of the enclosure (45, 46, 47).

31. A beam line according to claim 27, wherein the focused EUV beam (55) leaves the vacuum chamber (38) in a direction essentially opposite a direction of the entering laser beam (41).

32. A beam line according to claim 27, wherein a higher pressure in the enclosure (45, 46, 47; 66) is achieved by means of at least one gas ejector (67), which directs ejected gas (68) onto the mirror (49, 64) facing the plasma.

33. A beam line according to claim 27, wherein the enclosure (66) is provided with a beam entrance part (61), which is preferably exchangeable, and the hole area and the flow ejection direction of which can preferably be varied.
